(19) United States
(12) Patent Application Publication
(10) Pub. No.: US 2014/0137661 A1
(43) Pub. Date: May 22, 2014

(54) METHOD FOR DEMONSTRATING THE STRENGTH OF A FIBROUS STRUCTURE

(71) Applicant: THE PROCTER & GAMBLE COMPANY, Cincinnati, OH (US)

(72) Inventors: Ann Marie WOULMS, Milan, IN (US); Gregg Thoms WEAVER, Liberty Township, OH (US)

(73) Assignee: THE PROCTER & GAMBLE COMPANY, Cincinnati, OH (US)

(21) Appl. No.: 13/680,266

(22) Filed: Nov. 19, 2012

(51) Int. Cl. G01N 3/08

(52) U.S. Cl. CPC G01N 3/08
USPC 73/834

(57) ABSTRACT

A method for demonstrating the strength of an absorbent product. The method can include providing a first and second absorbent product; providing, for each of the first and second products, an upper and a lower holding clamp; attaching one of the upper holding clamps to each of the first and second absorbent products; attaching one of the lower holding clamps to each of the first and second absorbent products; optionally, attaching a first predetermined weight to the lower holding clamp; wetting each of the first and second absorbent products with a wetting fluid; waiting until one of the first or second absorbent products fails in tension; optionally, (i) spray a second predetermined amount of the wetting fluid; or (ii) add a second predetermined weight to the lower holding clamp; repeating certain steps until the absorbent product fails in tension.

### FIELD OF THE INVENTION

This invention relates to the field of fibrous structures, and particularly to the field of demonstrating strength characteristics of fibrous structures.

### BACKGROUND

Fibrous structures are used in many consumer items, particularly as fibrous paper products. Paper products such as facial tissue, bath tissue, and paper towels are used by many consumers for many cleaning tasks. In particular, paper towels which are usually sold on a roll are often used for wet tasks, such as cleaning windows, cleaning up spills and scrubbing countertops. For this reason it can be important that absorbent paper products have sufficient strength for expected tasks. It is particularly important that absorbent paper products such as paper towels retain a certain strength when wet.

When marketing absorbent paper products, such as paper towels, it can be important to demonstrate to a potential consumer the strength of the absorbent paper product. For example, it can be important to demonstrate to a consumer the wet strength of a paper towel. Furthermore it can be important to demonstrate to a consumer the wet strength of one paper towel in relation to another paper towel.

Accordingly, there is an unmet need for a new and better way of demonstrating to a potential consumer the strength characteristics of a fibrous structure.

Additionally there is an unmet need for a new and better way of demonstrating to a potential consumer the strength characteristics of a paper towel.

Further, there is an unmet need for a new and better way of demonstrating to a potential consumer the relative strength characteristics of one paper towel, with respect to another paper towel.

Still further, there is an unmet need for a new and better way of demonstrating to a potential consumer the relative strength characteristics of a wet paper towel, particularly with respect to another wet paper towel.

### SUMMARY OF THE INVENTION

A method for demonstrating the strength of an absorbent product is disclosed. The method can be used to demonstrate the strength, including the wet strength of a single absorbent product, such as a paper towel. In an embodiment, the method includes steps for demonstrating the strength of first absorbent product relative to a second absorbent product. The method can include:
a. providing a first absorbent product and a second absorbent product, each of the absorbent products having a length and a width, wherein each of the absorbent products has a top edge and a bottom edge;
b. providing, for each of the first and second products, an upper holding clamp and a lower holding clamp, each of the holding clamps having means for gripping one of the top edge or the bottom edge across the width;
c. attaching one of the upper holding clamps to each of the first and second absorbent products along their respective the top edges;
d. attaching one of the lower holding clamps to each of the first and second absorbent products along their respective the bottom edges, wherein the weight of the lower holding clamp applies a generally uniform tension across the width;
e. optionally, attaching a first predetermined weight to the lower holding clamp for applying additional generally uniform tension across the width;
f. wetting each of the first and second absorbent products with a first predetermined amount of a wetting fluid;
g. waiting until one of the first or second absorbent products fails in tension;
h. optionally,
   i. spray a second predetermined amount of the wetting fluid; or
   ii. add a second predetermined weight to the lower holding clamp;
i. repeating step (h) until the absorbent product fails in tension.

### BRIEF DESCRIPTION OF THE DRAWINGS

FIG. 1 is an elevation view of an apparatus useful for the present invention.

FIG. 2 is a side profile view of an apparatus of the present invention taken along section 2-2 of FIG. 1.

FIG. 3 is a side elevation view of an apparatus useful for doing a comparison demonstration in accordance with the present invention.

### DETAILED DESCRIPTION OF THE INVENTION

The method of the present invention provides for a demonstration to illustrate the dry or wet strength of an absorbent product, particularly a cellulosic absorbent product in the form of a paper towel. In the description below, therefore, the invention will be illustrated with respect to a paper towel. However the invention can be utilized for various other absorbent products, including bath tissue, facial tissue, wipes, and the like.

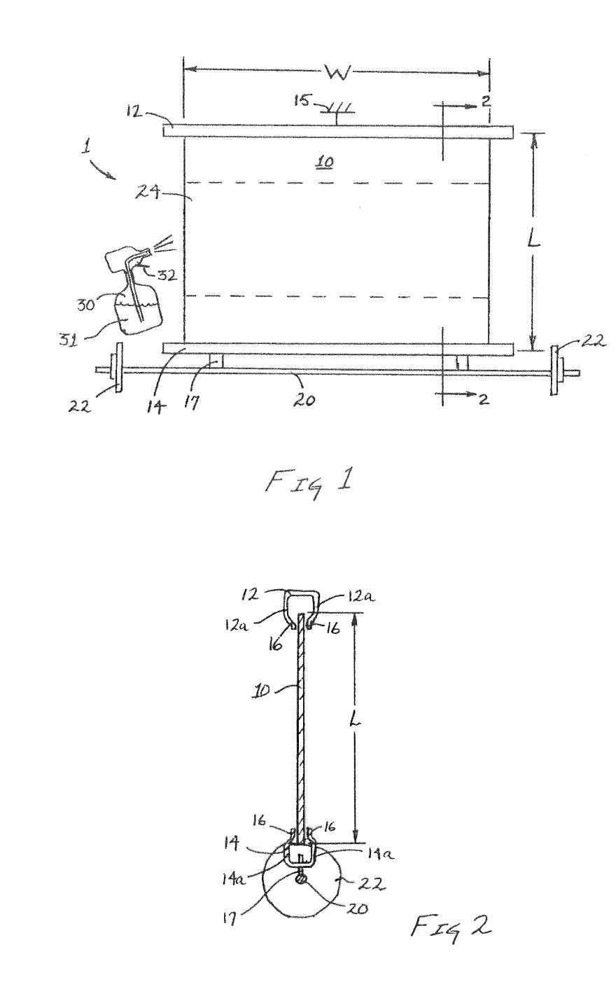

As shown in FIG. 1, an apparatus 1 is shown for testing and demonstrating the strength, including the wet strength, of an absorbent product 10. The apparatus 1 includes an upper holding clamp 12, a lower holding clamp 14, each of which holding clamps grip opposing edges of absorbent product 10. As shown in FIG. 1, absorbent product 10 can hang freely in a vertical orientation when held securely in upper holding clamp 12 which can itself be secured to a stationary object 15. Absorbent product 10 can have a length L, and a width W. As the dimensions relate to roll products such as paper towels, the width W dimension corresponds to the cross machine direction, and the length L dimension corresponds to the machine direction. Therefore, absorbent product 10 can represent a single sheet of a paper towel which has been removed, such as by tearing at the perforations, from a roll of paper towels.

Upper and lower holding clamps, 12 and 14, can secure the respective opposing edges of absorbent product 10, by any means known in the art. As shown in cross-section 2-2 in FIG. T, for example, upper holding clamp 12 and lower holding clamp 14 can be substantially identical and can have movable opposing sides 12a and 14a, respectively, that can be drawn together at their respective distal tips 16 to apply substantially even pressure sufficient to grip absorbent product 10 under a tensile load, as discussed below. In general, sufficient gripping pressure need be great enough only to hold the absorbent product during the testing demonstration, as discussed below, such that there is little to no relative movement between the closed distal end 16 an absorbent product 10 during the demonstration. Distal tips 16 can apply sufficient force to apply sufficient pressure to the edges of absorbent product 10, by any means known in the art. For example, opposing sides 12a and 14a can be designed to have a spring action such that distal tips 16 are biased toward one another on each of upper clamp 12 and lower clamp 14. In another embodiment, opposing sides 12a and 14a can be drawn inwardly by a screw or bolt (not shown) extending laterally through both sides 12a and 14a, such that by a threaded means, sides 12a or 1 a can be drawn together to apply sufficient pressure that distal tips 16.

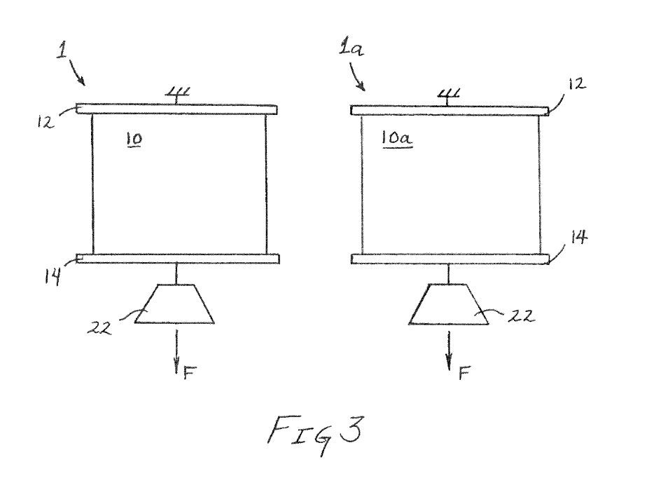

Lower holding clamp 14 can have a weight such that alone it is sufficient to apply a downward tensile loading to absorbent product 10 such that upon wetting absorbent product 10 the weight of lower holding clamp 14 is sufficient to cause absorbent product 10 to fail in tension. However, in one embodiment a separate device is used to apply a predetermined weight to lower holding clamp 14, which weight, of course, applies tension to absorbent product 10. For example, as shown in FIG. 1, a bar 20 having a length which, when centered in line with a vertically oriented centerline of absorbent product 10, has a width substantially equal to or greater than width W. Bar 20 can be connected to lower holding clamp 14 by any method as known in the art, for example, by screwing, by clamps, by straps, or by joining by adhesion, or combinations thereof. In an embodiment, weights 22, can be can be added to bar 20. For example as shown in FIG. 1 and in cross-section in FIG. 2 weights 22 can be round metal weights each of predetermined weight, and each having in the center there of a hole such that weights 22 can be inserted on to bar 20 with bar 20 passing through the central hole of each weight 22. Weights 22 can be of predetermined weight and the bar 20 can have sufficient length such that additional weights 22 can be added to increase the weight, and therefore, the tension applied by lower holding bar 14 to absorbent product 10.

Once the apparatus 1 is set up as shown, for example, in FIG. 1, absorbent product 10 can be tested for dry strength with a visual demonstration that includes applying a predetermined amount of a weight to absorbent product 10, and incrementally increasing the weight until the absorbent product fails by tearing. Therefore, as can be understood by this description and the apparatus as illustrated in FIG. 1, an absorbent product that can hold the weight of lower holding bar 14 and, optionally, the additional predetermined weight of bar 20 and weights 22 when dry, may fail when additional weights 22 are added.

In a similar manner, the apparatus 1 can be set up as shown, for example, in FIG. 1, such that absorbent product 10 can be tested for wet strength with a visual demonstration that includes spraying or otherwise applying a predetermined amount of a fluid to absorbent product 10. Applying a fluid, such as water, to an absorbent product often decreases the tensile strength of such an absorbent product. Particularly in cellulosic absorbent paper products, such as paper towels, applying a fluid to the paper towel tends to weaken it in tension. Therefore, as can be understood by this description and the apparatus as illustrated in FIG. 1, an absorbent product that can hold the weight of lower holding bar 14 and, optionally, the additional predetermined weight of bar 20 and weights 22 when dry, may fail when absorbent product 10 is wetted.

A method of the invention utilizing the illustrated apparatus starts with providing an absorbent product having a length dimension and a width dimension. The length and width dimensions of absorbent product 10 can be equal. The absorbent product can be generally rectangular shaped. The absorbent product can be a cellulosic absorbent paper product, and can be a paper towel. The paper towel can be one from a roll of paper towels. The method includes providing an upper holding clamp 12 for holding the top edge along its width W. Upper holding clamp 12 can be mounted to any stable and stationary object 15. A lower holding clamp 14 is also provided and positioned to generally uniformly and evenly clamp the bottom edge of absorbent product 10 along the width W of the absorbent product. Once upper holding clamp and lower holding clamp are in place, which can be in a substantially parallel relationship, the absorbent product should hang freely in a vertical orientation.

The method of the invention includes optionally adding weight to the apparatus by connecting weight to lower holding clamp 14. For example, a round bar 20 can be connected to lower holding clamp 14 by clamps 17 which securely hold bar 20 in a generally parallel relationship with respect to lower holding clamp 14. If additional weight is desired, weights 22 can be added on to bar 20 until the desired weight pulling in downward tension on absorbent product 10 is reached.

Once absorbent product 10 is held in a hanging relationship by upper holding clamp 12 and lower holding clamp 14, and optionally after adding additional weights 20, 22, the absorbent product can be tested for wet strength by wetting in any suitable manner. Wetting can be achieved by applying a fluid, such as water, to the absorbent product. In one embodiment wetting is achieved by spraying a predetermined number of sprays from a spray bottle 30, as shown in FIG. 1. Spray bottle 30 can be any spray bottle for spraying a generally dispersed fine spray of water on to a surface of absorbent product 10. In one embodiment the number of pulls of a trigger 32 on spray bottle 30 can be from one to about 20, or from about four to about 30, or from about five to about 10. In one embodiment sprays of water from a spray bottle 30 are generally uniformly applied across the width of the absorbent product 10 generally in the mid-section 24, as indicated by the dashed lines in FIG. 1. In one embodiment spray bottle 30 is held between three and 12 inches from the surface of absorbent product 10 during spraying.

In one embodiment additional sprays of wetting fluid, for example, water, from spray bottle 30 can be made until tensile failure occurs due to the weakening of the absorbent product 10 when wetted sufficiently. In another embodiment, for a predetermined amount of spray from spray bottle 30, additional weight can be added to bar 20 in a stepwise fashion until sufficient weight is added to cause absorbent product 10 to fail in tension. In another embodiment, for a predetermined amount of wetting of absorbent product 10, the time between wetting and failure in tension can be measured.

Wetting can be accomplished in any known manner including spraying by means other than by spray bottle, as depicted in FIG. 1. In general, for demonstration purposes it is believed that wetting should occur generally uniformly across the full width of absorbent product 10. In an embodiment wetting can be performed by spraying in a generally uniform manner in a band 24 across width W of absorbent product 10 as indicated by the band between the dashed lines in FIG. 1.

In an embodiment one or more apparatus 1 can be utilized to show comparative results of two absorbent products 10. For example, as shown in FIG. 3, two absorbent products 10 and 10a can be set up substantially identically into apparatuses 1 and 1a. As shown in FIG. 3, each apparatus 1 and 1a can be set up identically as described in FIG. 1. In FIG. 3, however, rather than a bar 20 with weights 22 added on each end, the weights shown in FIG. 3 can be single weights hung substantially in the center of lower holding clamp 14. In an embodiment, absorbent product 10 is different from absorbent product 10a. For example, absorbent product 10 can be a paper towel by a first manufacturer, and absorbent product 10a can be a paper towel made by a second, different manufacturer.

The method of the present invention when utilized in a comparative demonstration, can utilize two or more apparatuses as shown in FIG. 3 with each absorbent product being subjected to identical, or substantially identical wetting. Therefore, in one embodiment a spray bottle 30 as discussed above with respect to FIG. 1, can be used to spray absorbent product 10 and absorbent product 10a, delivering substantially the same amount of fluid and in substantially the same locations or patterns with respect to each absorbent product 10, and 10a. Thus, once absorbent products 10 and 10a are each held in a hanging relationship by their respective upper holding clamps 12 and lower holding clamps 14, and optionally after adding weights 20, each absorbent product can be tested for wet strength by wetting in any suitable manner. Wetting can be achieved by applying a fluid, such as water, to each absorbent product. In one embodiment wetting is achieved by spraying a predetermined number of sprays from a spray bottle 30 on each absorbent product, such as on both of absorbent products 10 and 10a in FIG. 3. As discussed above, wetting, whether by spraying or other means, can be applied in any manner to deliver generally uniform, and in the case of absorbent products, generally identical amounts of fluid to the absorbent products.

Therefore, in an embodiment for demonstrating the strength of an absorbent product, particularly when wet, the method involves providing two absorbent products each having generally the same size and shape. Thus, for example, two paper towels of generally the same overall size can be tested in a side-by-side demonstration by each paper towel being arranged in an apparatus, for example in an arrangement in accordance with the description above with respect to FIG. 3. Once absorbent products are hanging in their respective apparatuses, fluid can be delivered to wet each of the absorbent products in a substantially uniform and equal amount, such that upon wetting the comparative wet strength characteristics of each absorbent product can be compared. As discussed above, the comparative wet strength characteristics of each absorbent product being tested in a side-by-side comparison can be determined by comparing the amount of fluid required for a given weight before failure in tension occurs; by determining the time for a given amount of wetting and a given amount of weight, before failure in tension occurs; or by determining the amount of weight an absorbent product can hold after a predetermined amount of wetting before failure in tension occurs.

In one embodiment a demonstration can be filmed for visual viewing by others later. For example, two absorbent products, such as competitive brands of paper towels, can be arranged in side-by-side apparatuses in which the top edge and bottom edges are uniformly held across their respective width. Once each paper towel is hanging in a dry stable condition, wetting can be applied, for example, by use of a spray bottle generally uniformly spraying an equal amount and placement of wetting fluid, such as water, across the width of each paper towel. If each paper towel, after wetting, remains intact, either additional wetting can be applied, or additional weight can be applied in order to show which competitive brand of paper towel ultimately fails first in tension.

In any embodiment of the present invention, it can be understood that the demonstration can be modified according the desired communication to be made by varying fluid application, time, weight, or combinations of all three. For example, it may be desirable to show that a particular paper towel, being wetted by a certain amount of fluid, remains strong enough to retain physical integrity for a certain amount of time. Likewise, it may be desirable to show that a particular paper towel, being wetted by a certain amount of fluid, can retain physical integrity under the influence of a larger amount of weight than, for example, a paper towel marketed by a competitor.

Other physical configurations are contemplated as serving a similar function and providing the benefit of a visual demonstration of strength. For example, in an embodiment, an absorbent product, such as a paper towel, can be positioned horizontally, with opposing edges attached to weights by know means, such as clamps as described above, with the clamped edges being pulled in tension by weights draped over appropriately spaced turning bars and pulling under the influence of gravity. As with the method described above, weights can be added in incremental amounts until failure of the paper towel occurs, at which time the weights can fall freely under the influence of gravity. Other demonstration techniques can also be utilized in the method of the present invention. For example, visual and audio clues, such as the visual of a paper towel being “snapped” taut can be shown. For example, at the beginning, end, or during the demonstration as described above, a visual representation can be shown of a person snapping taut a paper towel, with or without an accompanying sound of the snapping motion.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for demonstrating the strength of a first absorbent product relative to a second absorbent product, the method comprising:
a. providing a first absorbent product and a second absorbent product, each said absorbent product having a length and a width, wherein each said absorbent product has a top edge and a bottom edge;
b. providing, for each said first and second product, an upper holding clamp and a lower holding clamp, each said holding clamp having means for gripping one of said top edge or said bottom edge across said width;
c. attaching one of said upper holding clamps to each of said first and second absorbent products along their respective said top edges;
d. attaching one of said lower holding clamps to each of said first and second absorbent products along their respective said bottom edges, wherein the weight of said lower holding clamp applies a generally uniform tension across said width;
e. optionally, attaching a first predetermined weight to said lower holding clamp for applying additional generally uniform tension across said width;
f. wetting each of said first and second absorbent products with a first predetermined amount of a wetting fluid;
g. waiting until one of said first or second absorbent products fails in tension;
h. optionally,
i. spraying a second predetermined amount of said wetting fluid; or
ii. adding a second predetermined weight to said lower holding clamp;
i. repeating step (g) until said absorbent product fails in tension.

2. The method of claim 1, wherein said absorbent product is generally rectangular shaped.

3. The method of claim 1, wherein said first and second predetermined weights comprise a bar attached to said lower holding clamp.

4. The method of claim 1, wherein said wetting fluid comprises a color that contrasts with a color of said absorbent product.

5. The method of claim 1, wherein said absorbent product is a cellulosic absorbent paper product.

6. The method of claim 1, wherein said cellulosic absorbent paper product is selected from the group consisting of, bath tissue, facial tissue, and paper towel.

7. The method of claim 1, wherein said absorbent product is a paper towel.

8. The method of claim 7, wherein said paper towel comprises embossments.

9. The method of claim 7, wherein said paper towel is uncreped.

10. A method for demonstrating the strength of an absorbent product, the method comprising:
a. providing a first absorbent product, said first absorbent product having a length, a width, a top edge and a bottom edge;
b. providing, for said first absorbent product, an upper holding clamp and a lower holding clamp, each said holding clamp having means for gripping one of said top edge or said bottom edge across said width of said first absorbent product;
c. attaching said upper holding clamp to said first absorbent product along said top edge;
d. attaching said lower holding clamp to said first absorbent product along said bottom edges;
e. wetting said first absorbent product with a first predetermined amount of a wetting fluid;
f. optionally,
i. recording a time until said first absorbent product fails in tension; or
ii. spraying a second predetermined amount of said wetting fluid on said first absorbent product; or
iii. adding a first predetermined weight or an additional predetermined weight to said lower holding clamp of said first absorbent product for applying generally uniform tension across said bottom edge of each of said first absorbent product;
g. repeating step (f) until said first absorbent product fails in tension.

11. The method of claim 10, wherein said first absorbent product is generally rectangular shaped.

12. The method of claim 10, wherein said first predetermined weight comprises a bar attached to said lower holding clamp.

13. The method of claim 10, wherein said wetting fluid comprises a color that contrasts with a color of said first absorbent product.

14. The method of claim 10, wherein said first absorbent product is a cellulosic absorbent paper product.

15. The method of claim 14, wherein said cellulosic absorbent paper product is selected from the group consisting of, bath tissue, facial tissue, and paper towel.

16. The method of claim 15, wherein said cellulosic absorbent product is a paper towel, and said paper towel comprises embossments.
